(19) United States
(12) Patent Application Publication
(10) Pub. No.: US 2026/0287486 A1
(43) Pub. Date: Sep. 24, 2026

(54) CORIOLIS MASS FLOW AND DENSITY METER

(71) Applicant: Endress+Hauser Flowtec AG, Reinach (CH)

(72) Inventors: Ennio Bitto, Aesch (CH); Gerhard Eckert, Grenzach-Wyhlen (DE); Mattia Alioli, Binningen (CH)

(21) Appl. No.: 19/476,635

(22) PCT Filed: Apr. 15, 2024
(86) PCT No.: PCT/EP2024/060186

§ 371 Date: Oct. 17, 2025

(30) Foreign Application Priority Data
Apr. 19, 2023 (DE) 10 2023 109 943.4

(51) Int. Cl. G01N 9/00; G01F 1/84

(52) U.S. Cl. CPC G01N 9/002; G01F 1/8422; G01F 1/8427; G01F 1/8431; G01F 1/8472; G01N 2009/006

(57) ABSTRACT

A Coriolis mass flow and density meter includes: at least one first oscillatory measuring tube; at least one support body; at least one exciter; at least one first reinforcement body, and a measuring and operating circuit, wherein the at least one first reinforcement body has, at least in portions, a helical profile with multiple windings, wherein the measuring and operating circuit is configured to determine the density measurement value using a natural frequency of a bending oscillation mode of the at least one first measuring tube, wherein the natural frequency has a low pressure dependency such that a pressure-dependent deviation of the density measurement value from an actual density of a medium has a pressure dependency that is no more than 100 ppm/bar.

The present invention relates to a Coriolis mass flow and density meter. Generic Coriolis mass flow meters are disclosed, for example, in EP 1 427 998 B1 and WO 2016/202537 A1.

They comprise at least one first oscillatory measuring tube for guiding a medium; at least one support body, wherein the at least one first measuring tube is connected to the support body at the inlet side and at the outlet side; at least one exciter for exciting at least one bending vibration mode of the at least one first measuring tube; at least two vibration sensors for detecting vibrations of the at least one first measuring tube; and at least one first reinforcing body which is fastened to a lateral surface of the at least one first measuring tube in order to reduce cross-sensitivity of the calibration factor calf for measuring the mass flow rate to the media pressure. The reinforcing bodies of the devices according to the prior art are designed as rings which are to be precisely positioned as individual parts on the measuring tubes and fastened thereto. Although this fulfills the intended purpose, it is relatively expensive and prone to errors during assembly.

The object of the present invention is, therefore, to find a remedy.

The object is achieved according to the invention by the Coriolis mass flow meter and density meter according to independent claim 1.

The Coriolis mass flow and density measuring apparatus according to the invention comprises: at least one first oscillatory measuring tube for guiding a medium; at least one support body, wherein the at least one first measuring tube is connected to the support body on the inlet side and the outlet side; at least one exciter for exciting at least one bending vibration mode of the at least one first measuring tube; at least two vibration sensors for detecting vibrations of the at least one first measuring tube; at least one first reinforcement body, which is fastened to a lateral surface of the at least one first measuring tube and surrounds the at least one first measuring tube, wherein the at least one first reinforcement body has, at least in portions, a helical profile with multiple windings, and a measuring and operating circuit for driving the exciter, for detecting signals from the vibration sensors, and for determining a mass flow rate measurement value and/or a density measurement value depending on the signals from the vibration sensors, wherein the distance between two adjacent windings of the reinforcement body is not less than twice, for example not less than four times, and in particular not less than eight times the material thickness of the reinforcement body in the region of the windings, wherein a measuring and operating circuit is configured to determine the density measurement value depending on a natural frequency of a bending vibration mode of the at least one measuring tube, wherein the natural frequency has such a low pressure dependence that a pressure-dependent deviation of the density measurement value from an actual density of a flow guided in the measuring tube medium has a pressure dependency that is no more than 100 ppm/bar, in particular no more than 50 ppm/bar,

In a further development of the invention, the material thickness of the at least one first reinforcing body is not less than half, for example not less than three quarters of a wall thickness of the at least one first measuring tube.

In a further development of the invention, the at least one first measuring tube has a first material, the at least one first reinforcing body having a second material, and the thermal expansion coefficient of the first material not deviating from the thermal expansion coefficient of the second material by more than 2 ppm/K, for example not by more than 1 ppm/K and in particular not by more than 0.5 ppm/K.

In a further development of the invention, the first material and the second material are metallic.

In a further development of the invention, the at least one reinforcing body is connected to the at least one measuring tube by means of at least one joint, which in particular comprises a hard solder connection.

In a further development of the invention, the hard solder connection comprises a nickel-based solder, in particular a solder of type AMS 4777, BNi-2.

In a further development of the invention, the at least one joint extends over at least one, for example at least two and in particular at least three windings of the at least one reinforcing body around the at least one measuring tube.

In a further development of the invention, the at least one reinforcing body has at least one section which comprises at least three, for example at least six and in particular at least eight continuous windings.

In a further development of the invention, the at least one measuring tube has a mirror-symmetrical profile with respect to a measuring tube transverse plane, wherein the at least one measuring tube has at least one section that is bent in the rest position of the measuring tube between the measuring tube transverse plane and an end of the measuring tube at the inlet side, in which section the direction of a measuring tube center line of the at least one measuring tube changes by an angle δ that is not smaller than 30°, the at least one reinforcement body in the bent section having no fewer than a windings, wherein the following applies: a≥δ/20°, for example a≥δ/15°, and in particular a≥δ/10°

In a further development of the invention, the measuring tube has a mirror-symmetrical profile with respect to a measuring tube transverse plane, wherein the measuring tube has at least one section that is bent in the rest position of the measuring tube between the measuring tube transverse plane and an end of the measuring tube on the inlet side, in which section the direction of a measuring tube center line changes by an angle δ that is not smaller than 30°, the measuring tube having an inner diameter d, the measuring tube center line in the bent section having an effective radius of curvature r_{K}, wherein a ratio V=4·d/r_{K} is defined, wherein the at least one reinforcement body in the bent section has no fewer than b windings, wherein the following applies: b≥δ·V/20°, for example b≥δ·V/15°, and in particular b≥δ·V/10°.

In a further development of the invention, the reinforcing body has a first section with windings which surround the measuring tube, the reinforcing body having a second section with windings which surround the measuring tube, a connection section running between the first section and the second section, the length of the connection section being not more than twice the distance of the first section from the second section in the direction of the measuring tube center line.

In a further development of the invention, a calibration factor calf can be determined for the meter, which calibration factor describes a proportional relationship between a mass flow rate dm/dt to be measured and a phase difference or time difference between signals of the vibration sensors,
wherein the calibration factor calf has a relative cross-sensitivity Δcalf (Δp) to the difference Δp between the pressure in the measuring tube and the pressure in the region surrounding the measuring tube, which is given as

$$Δ calf ( Δ p ) := ( calf ( p ) - calf ( p 0 ) ) / calf ( p 0 )$$

wherein the following applies to the absolute value of relative cross-sensitivity |Δcalf (Δp)| at a temperature equilibrium between the medium, the measuring tube and the region surrounding the meter at a temperature of 300 K in a linear approximation:

$$\vert Δ calf ( Δ p ) \vert < S \cdot {d}_{i} / t \cdot Δ p ,$$

wherein di is the inner diameter of the at least one measuring tube, t describes the wall thickness of the at least one measuring tube and S is an upper proportionality limit for which the following applies: S<6 ppm/bar, for example S<5 ppm/bar and in particular S<4 ppm/bar.

In a further development of the invention, a calibration factor calf can be determined for the meter, which calibration factor describes a proportional relationship between a mass flow rate dm/dt to be measured and a phase relationship or time difference between signals of the vibration sensor at the inlet side and the vibration sensor at the outlet side,
wherein the calibration factor calf has a relative cross-sensitivity Δcalf (Δp) to the difference Δp between the pressure in the measuring tube and the pressure in the region surrounding the measuring tube, which is given as

$$Δ calf ( Δ p ) := ( calf ( p ) - calf ( p 0 ) ) / calf ( p 0 )$$

wherein the following applies to the absolute value of relative cross-sensitivity |calf (Δp)| at a temperature equilibrium between the medium, the measuring tube and the region surrounding the meter at a temperature of 300 K in a linear approximation:

$$\vert Δ calf ( Δ p ) \vert = K \cdot Δ p ,$$

wherein K is a device-specific constant,
wherein the following applies to the absolute value of the relative cross-sensitivity of a reference meter in a linear approximation:

$$\vert Δ {calf}_{ref} ( Δ p ) \vert = {K}_{ref} \cdot Δ p$$

wherein the reference meter is identical to the Coriolis mass flow and density meter except for the reinforcing body which is omitted from the reference meter, wherein the following applies: K_{ref}/K>2, in particular K_{ref}/K>3.

In a further development of the invention, the Coriolis mass flow and density meter further comprises: at least one second oscillatory measuring tube for guiding a medium which is substantially structurally identical to the at least one first measuring tube and is guided parallel to said first measuring tube; at least one second reinforcing body which is fastened to a lateral surface of the at least one second measuring tube and surrounds the at least one second measuring tube, wherein the at least one second reinforcing body has, at least in portions, a helical profile with a plurality of windings, wherein the distance between two adjacent windings of the at least one second reinforcing body is not less than twice, for example not less than four times, and in particular not less than eight times the material thickness of the at least one second reinforcing body in the region of the windings, the material thickness of the at least one second reinforcing body in the region of the windings being equal to the material thickness of the at least one first reinforcing body in the region of the windings, wherein the distance between the at least one first measuring tube and the at least one second measuring tube is greater than the simple material thickness of the first and second reinforcing bodies in the region of the windings, and wherein the distance between the at least one first measuring tube and the at least one second measuring tube is less than twice the material thickness of the reinforcing bodies in the region of the windings.

In a further embodiment of the invention, the outer diameter of the measuring tube divided by the cross-sectional area of the reinforcing body is not less than 1.5/mm and/or not more than 3/mm, in particular not more than 2.5/mm. This limits the mass of the reinforcement body, which reduces the relative mass contribution of the measuring medium, and specifies a minimum thickness of the reinforcement body in order to reduce pressure-dependent measurement errors.

The invention is now explained in more detail on the basis of the exemplary embodiments shown in the figures. in which:

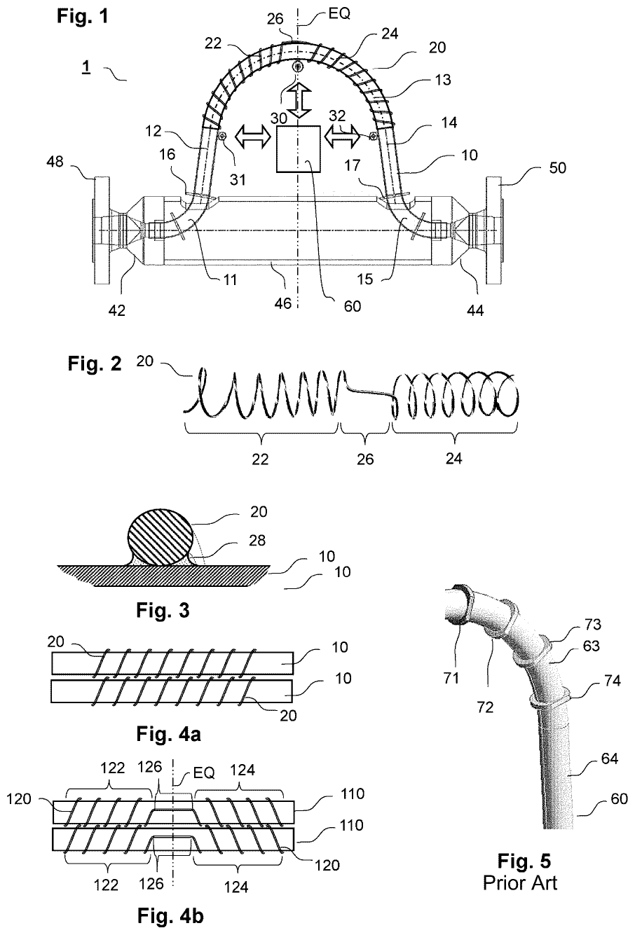

FIG. 1: is an overall view of an exemplary embodiment of a Coriolis mass flow meter according to the invention;

FIG. 2: is an exemplary embodiment of a reinforcing body of a Coriolis mass flow meter according to the invention;

FIG. 3: is a detailed view of a longitudinal section through a measuring tube of an exemplary embodiment of a Coriolis mass flow meter according to the invention;

FIG. 4a: is a schematic plan view of a section of two parallel-guided measuring tubes of an exemplary embodiment of a Coriolis mass flow meter according to the invention;

FIG. 4b: is a schematic plan view of a section of two parallel-guided measuring tubes of a further exemplary embodiment of a Coriolis mass flow meter according to the invention; and

FIG. 5: is a detailed view of a measuring tube with reinforcing bodies of a Coriolis mass flow meter according to the prior art.

The exemplary embodiment of a Coriolis mass flow meter 1 according to the invention shown in FIG. 1 comprises two parallel measuring tubes 10 with an inner diameter of more than 15 mm and a wall thickness of 0.9 mm, which are made of stainless steel, for example 1.4404 or Hastelloy. The nominal diameter of the Coriolis mass flow meter 1 is DN 25. The measuring tubes 10 run symmetrically with respect to a measuring tube transverse plane EQ and each have an inlet bend 11, a first straight section 12, an apex bend 13, a second straight section 14 and an outlet bend 15. The measuring tubes 10 are connected to one another at least with a coupler 16 on the inlet side and a coupler 17 on the outlet side, a vibration length of the measuring tubes being determined by the couplers. The inlet bends 11 of the two measuring tubes 10 are connected to a flow divider 42 on the inlet side which has a flange 48 on the inlet side for connection to a pipeline. The outlet bends 15 of the two measuring tubes 10 are connected to a flow divider 44 on the outlet side which has a flange 50 on the inlet side for connection to the pipeline. The two flow dividers 42, 44 are rigidly connected to one another via a solid support tube 46 in order to largely suppress relative movements of the flow dividers to one another.

In order to excite measuring tube vibrations in a bending vibration mode, the Coriolis mass flow and density meter 1 has an electrodynamic exciter arrangement 30 which acts between the measuring tubes 10 and is arranged symmetrically to the measuring tube transverse plane EQ. In order to detect the measuring tube vibrations, the Coriolis mass flow and density meter 1 has an electrodynamic vibration sensor 31 on the inlet side and an electrodynamic vibration sensor 32 on the outlet side, which are set up to detect the relative movements of the measuring tubes 10 to one another at the associated sensor position. A time difference or phase difference between the sensor signals of the two vibration sensors is proportional to the mass flow rate through the measuring tubes. Accordingly, the mass flow rate can be determined by multiplying a phase difference or time difference using a calibration factor calf which describes this proportionality.

The exemplary embodiment of a Coriolis mass flow measuring apparatus 1 according to the invention further comprises a measuring and operating circuit 60 for driving the excitation arrangement 30, for detecting signals from the vibration sensors 31, 32, and for determining a mass flow rate measurement value and/or a density measurement value in dependence on the signals from the vibration sensors.

The calibration factor calf depends on a modal bending resistance of the measuring tubes, which in turn is pressure-dependent. The calibration factor calf therefore has a cross-sensitivity to the media pressure. In order to reduce this cross-sensitivity of the calibration factor to the media pressure, a reinforcing body 20 in the form of a helical spring is in each case guided around the apex bends 13 of the measuring tubes 10 and fixed to the measuring tube by means of a hard solder, in particular a nickel-based solder such as BNi-2. A joint formed with the hard solder preferably extends over the entire length of the reinforcing body. The helical spring—like the measuring tube—is made of stainless steel, for example 1.4310, 1.430. A duplex wire is suitable for a measuring tube made of Hastelloy, since a duplex wire can be better soldered to the Hastelloy and has a better thermal expansion coefficient. It must be ensured that the thermal expansion coefficient substantially corresponds to that of the material of the helical spring of the measuring tube, but in any case does not deviate from it by more than 1 ppm/K. The helical spring has a material thickness of, for example, 2 mm. A Coriolis mass flow and density meter with measuring tubes reinforced in this way has a considerably lower cross-sensitivity of the calibration factor calf to the media pressure than a Coriolis mass flow and density meter with measuring tubes without reinforcing bodies. In the exemplary embodiment, the pressure dependence is reduced to less than one third of the value for a Coriolis mass flow and density meter with such measuring tubes without reinforcing bodies.

The measuring tube 60 shown in FIG. 5 of a Coriolis mass flow meter with two measuring tubes according to the prior art differs from the exemplary embodiment from FIG. 1 with regard to the type of reinforcing bodies, which are formed here as separate rings 71, 72, 73, 74. The cross-sensitivity of the calibration factor calf to the media pressure is reduced in a comparable way to the Coriolis mass flow meter according to the invention, but the assembly of the reinforcing bodies according to the prior art is considerably more expensive, since the rings 71, 72, 73, 74 have to be precisely positioned individually and provided with solder material in order to avoid asymmetrical mass distributions. In contrast, the positioning, according to the invention, of the reinforcing body on the measuring tube of a Coriolis mass flow meter according to the invention is considerably simpler since the desired target position of the individual windings in the equilibrium state adjusts itself as a result of the elasticity of the helical spring. Furthermore, the use of the reinforcing bodies according to the present invention allows a smaller distance between the measuring tubes since the reinforcing function is distributed over more elements compared to the rings according to the prior art, with a winding being comparable to a ring.

Details of the reinforcing body are additionally shown in FIG. 2. The reinforcing body 20 comprises a metallic wire with a thickness of, for example, 1.5 mm with two helical spring sections 22, 24 with continuous sequences of windings, wherein the helical spring sections 22, 24 is connected by a straight connection section 26 which, in a first approximation, runs parallel to the longitudinal axis of the helical sections, but in any case does not deviate by more than 15° from the direction of the longitudinal axis of the helical sections. The inner diameter of the helical spring sections corresponds to the outer diameter of the apex bends 13 of the measuring tubes 10 in the equilibrium state. Thus, if the helical sections are slightly elastically twisted counter to their direction of rotation for assembly, in order to widen the inner diameter, they can be pushed almost without friction onto the measuring tubes and positioned. After relaxation of the elastic twist, the position of the reinforcing body on the measuring tube is fixed in a friction-locking manner. Here, a radial projection of the mass distribution of the reinforcing bodies 20 onto the center line of the corresponding measuring tube 10 is mirror-symmetrical to the measuring tube transverse plane EQ. The connection sections 26 each intersect the measuring tube transverse plane and thus bridge a winding-free region in which the exciter arrangement is arranged, as shown in FIG. 1.

For final fixing of the reinforcing bodies 20 on the measuring tubes 10, a hard solder material is applied along the reinforcing body 20, for example as a solder paste. In a high-temperature (vacuum) soldering process, the solder material is melted and wets the interfaces between the reinforcing bodies 20 and the corresponding measuring tube 10, whereby joints 30 are formed between the reinforcing bodies 20 and the measuring tubes 10 when the solder material cools, as shown in FIG. 3.

From the plan view in FIG. 4a of two parallel-guided measuring tubes 10 with reinforcing bodies 20, it can be seen that the windings of the reinforcing bodies have the same direction of rotation and in the space between the measuring tubes 10 at their widest point they each have a phase offset of half a winding relative to one another. This prevents the reinforcing bodies 20 from touching one another when the measuring tubes vibrate. The distance between the measuring tubes must therefore amount to at least only a material thickness of the reinforcing body. This aspect cannot be realized with the reinforcing rings according to the prior art, since these rings are mounted in the same position on adjacent measuring tubes. In order to still achieve a small measuring tube 11 distance, the reinforcing bodies can have lateral flattened regions, as shown in FIG. 5, which, on the one hand, weakens the reinforcing bodies and, on the other hand, requires expensive production.

FIG. 4b shows a further development of the invention with modified reinforcing bodies 120 in which, in contrast to the reinforcing bodies 20 in FIGS. 1 and 2, the direction of rotation of the helical spring sections 122, 124, which are each connected to one another by a connection section 126, is opposite. In this way, the mirror symmetry with respect to the measuring tube transverse plane EQ is maintained for the reinforcing bodies, which is not the case in the exemplary embodiment according to FIGS. 1 and 2. In this way, an already small influence of radial temperature gradients on the measuring tubes, for example when changing between media of different temperatures, can be further reduced.

1-15. (canceled)

16. A Coriolis mass flow and density meter, comprising:
at least one first oscillatory measuring tube configured to guide a medium;
at least one support body, wherein the at least one first measuring tube is connected to the at least one support body on an inlet side and on an outlet side;
at least one exciter configured to excite at least one bending vibration mode of the at least one first measuring tube;
at least two vibration sensors configured to detect vibrations of the at least one first measuring tube;
at least one first reinforcing body fastened to a lateral surface of the at least one first measuring tube and surrounding the at least one first measuring tube; and
a measuring and operating circuit configured to drive the at least one exciter, to detect signals from the at least two vibration sensors, and to determine a mass flow rate measurement value and/or a density measurement value depending on the signals from the at least two vibration sensors,
wherein the at least one first reinforcing body has, at least in sections, a helical profile including a plurality of windings, wherein a distance between two adjacent windings of the at least one first reinforcing body is not less than twice a material thickness of the at least one first reinforcing body in a region of the windings,
wherein the measuring and operating circuit is configured to determine the density measurement value using a natural frequency of a bending vibration mode of the at least one first measuring tube, the natural frequency having a low pressure dependence such that a pressure-dependent deviation of the density measurement value from an actual density of the medium guided in the measuring tube has a pressure dependence not more than 100 ppm/bar.

17. The Coriolis mass flow and density meter according to claim 16, wherein the actual density of the medium guided in the measuring tube has a pressure dependence not more than 50 ppm/bar.

18. The Coriolis mass flow and density meter according to claim 16, wherein the at least one first reinforcing body is not less than eight times the material thickness of the reinforcing body in the region of the windings.

19. The Coriolis mass flow and density meter according to claim 16, wherein the material thickness of the at least one first reinforcing body is not less than half of a wall thickness of the at least one first measuring tube.

20. The Coriolis mass flow and density meter according to claim 16, wherein the at least one first measuring tube includes a first material, and the at least one first reinforcing body includes a second material, wherein a thermal expansion coefficient of the first material does not deviate from a thermal expansion coefficient of the second material by more than 2 ppm/K.

21. The Coriolis mass flow and density meter according to claim 20, wherein a thermal expansion coefficient of the first material does not deviate from a thermal expansion coefficient of the second material by more than 0.5 ppm/K.

22. The Coriolis mass flow and density meter according to claim 20, wherein the first material is metallic, and wherein the second material is metallic.

23. The Coriolis mass flow and density meter according to claim 16, wherein the at least one first reinforcing body is connected to the at least one first measuring tube by means of at least one joint.

24. The Coriolis mass flow and density meter according to claim 23, wherein the at least one joint comprises a hard solder connection.

25. The Coriolis mass flow and density meter according to claim 24, wherein the hard solder connection comprises a nickel-based solder.

26. The Coriolis mass flow and density meter according to claim 23, wherein the at least one joint extends over at least one winding of the at least one first reinforcing body around the at least one first measuring tube.

27. The Coriolis mass flow and density meter according to claim 23, wherein the at least one joint extends over at least three windings of the at least one first reinforcing body around the at least one first measuring tube.

28. The Coriolis mass flow and density meter according to claim 16, wherein the at least one first reinforcing body has at least one section that comprises at least three continuous windings.

29. The Coriolis mass flow and density meter according to claim 16, wherein the at least one first reinforcing body has at least one section that comprises at least eight continuous windings.

30. The Coriolis mass flow and density meter according claim 16, wherein:
the at least one first measuring tube has a mirror-symmetrical profile relative to a measuring tube transverse plane;
the at least one first measuring tube has at least one curved section that is curved in a rest position of the at least one first measuring tube located between the measuring tube transverse plane and an end of the measuring tube on the inlet side;
in the at least one curved section, the direction of a measuring tube center line changes by an angle δ that is not smaller than 30°; and
the at least one first reinforcing body in the curved section includes no fewer than a windings, wherein the following applies: a≥δ/20°.

31. The Coriolis mass flow and density meter according to claim 30, wherein the following applies: a≥δ/10°.

32. The Coriolis mass flow and density meter according to claim 16, wherein:
the at least one first measuring tube has a mirror-symmetrical profile relative to a measuring tube transverse plane;
the at least one first measuring tube has at least one curved section that is curved in a rest position of the at least one first measuring tube located between the measuring tube transverse plane and an end of the measuring tube on the inlet side;
in the at least one curved section, the direction of a measuring tube center line changes by an angle δ that is not smaller than 30°; and
the at least one first measuring tube has an inner diameter d and the measuring tube center line in the at least one curved section has an effective radius of curvature r_{K}, wherein a ratio V=4·d/r_{K} is defined, wherein the at least one reinforcement body in the at least one curved section has no fewer than b windings, wherein the following applies: b≥δ·V/20°.

33. The Coriolis mass flow and density meter according to claim 32, wherein the following applies: b≥δ·V/10°.

34. The Coriolis mass flow and density meter according to claim 16, wherein:
the at least one first reinforcing body includes a first section including windings that surround the at least one first measuring tube;
the at least one first reinforcing body includes a second section including windings that surround the at least one first measuring tube; and
a connection section runs between the first section and the second section, wherein a length of the connection section is not more than twice a distance of the first section from the second section in a direction of a measuring tube center line.

35. The Coriolis mass flow and density meter according to claim 16, wherein a calibration factor calf is determinable for the meter, wherein the calibration factor describes a proportional relationship between a mass flow rate dm/dt to be measured and a phase difference or time difference between signals of the at least two vibration sensors,
wherein the calibration factor calf has a relative cross-sensitivity Δcalf (Δp) to a difference Δp between a pressure in the at least one first measuring tube and a pressure in a region surrounding the at least one first measuring tube, which is given as
$$Δ calf ( Δ p ) := ( calf ( p ) - calf ( p 0 ) ) / calf ( p 0 ) ,$$
wherein the following applies to an absolute value of the relative cross-sensitivity |calf (Δp)| at a temperature equilibrium between the medium, the at least one first measuring tube and the region surrounding the meter at a temperature of 300 K in a linear approximation:
$$\vert Δ calf ( Δ p ) \vert < S \cdot {d}_{i} / t \cdot Δ p ,$$
wherein di is an inner diameter of the at least one first measuring tube, t describes the wall thickness of the at least one first measuring tube and S is an upper proportionality limit for which the following applies: S<6 ppm/bar.

36. The Coriolis mass flow and density meter according to claim 35, wherein the following applies: S<4 ppm/bar.

37. The Coriolis mass flow and density meter according to claim 16, wherein a calibration factor calf is determinable for the meter, wherein the calibration factor describes a proportional relationship between a mass flow rate dm/dt to be measured and a phase difference or time difference between signals of the at least two vibration sensors,
wherein the calibration factor calf has a relative cross-sensitivity Δcalf (Δp) to a difference Δp between a pressure in the at least one first measuring tube and a pressure in a region surrounding the at least one first measuring tube, which is given as
$$Δ calf ( Δ p ) := ( calf ( p ) - calf ( p 0 ) ) / calf ( p 0 )$$
wherein the following applies to an absolute value of a relative cross-sensitivity |Δcalf (Δp)| at a temperature equilibrium between the medium, the at least one first measuring tube and the region surrounding the meter at a temperature of 300 K in a linear approximation:
$$\vert Δ calf ( Δ p ) \vert = K \cdot Δ p ,$$
wherein K is a device-specific constant,
wherein the following applies to the absolute value of the relative cross-sensitivity of a reference meter in a linear approximation:
$$\vert Δ {calf}_{ref} ( Δ p ) \vert = {K}_{ref} \cdot Δ p ,$$
wherein the reference meter is identical to the Coriolis mass flow and density meter except for the reinforcing body which is omitted from the reference meter, wherein the following applies:
$${K}_{ref} / K > 2 .$$

38. The Coriolis mass flow and density meter according to claim 37, wherein the following applies: Kref/K>3.

39. The Coriolis mass flow and density meter according to claim 16, further comprising:
at least one second oscillatory measuring tube configured to guide the medium which is substantially structurally identical to the at least one first measuring tube and runs parallel to the at least one first measuring tube;
at least one second reinforcing body fastened to a lateral surface of the at least one second measuring tube and surrounding the at least one second measuring tube,
wherein the at least one second reinforcing body has, at least in sections, a helical profile including a plurality of windings, wherein a distance between two adjacent windings of the at least one second reinforcing body is not less than twice a material thickness of the at least one second reinforcing body in a region of the windings,
wherein the material thickness of the at least one second reinforcing body in the region of the windings is equal to the material thickness of the at least one first reinforcing body in the region of the windings,
wherein a distance between the at least one first measuring tube and the at least one second measuring tube is greater than a material thickness of the at least one first and at least one second reinforcing bodies in the region of the windings, and
wherein the distance between the at least one first measuring tube and the at least one second measuring tube is less than twice the material thickness of the reinforcing bodies in the region of the windings.

40. The Coriolis mass flow and density meter according to claim 16, wherein an outer diameter of the at least one first measuring tube divided by a cross-sectional area of the at least one first reinforcing body is not less than 1.5/mm.

41. The Coriolis mass flow and density meter according to claim 16, wherein an outer diameter of the at least one first measuring tube divided by a cross-sectional area of the at least one first reinforcing body is not more than 3/mm.
